(19) United States
(12) Patent Application Publication
(10) Pub. No.: US 2024/0095927 A1
(43) Pub. Date: Mar. 21, 2024

(54) Segmentation Models Having Improved Strong Mask Generalization

(71) Applicant: Google LLC, Mountain View, CA (US)

(72) Inventors: Jonathan Chung-Kuan Huang, Seattle, WA (US); Vighnesh Nandan Birodkar, Montreal (CA); Siyang Li, Sunnyvale, CA (US); Zhichao Lu, Santa Clara, CA (US); Vivek Rathod, Santa Clara, CA (US)

(21) Appl. No.: 18/255,186

(22) PCT Filed: Mar. 4, 2021
(86) PCT No.: PCT/US2021/020865

§ 371 Date: May 31, 2023

(51) Int. Cl. G06T 7/11; G06V 10/77; G06V 10/774; G06V 10/82

(52) U.S. Cl. CPC G06T 7/11; G06V 10/7715; G06V 10/774; G06V 10/82; G06T 2207/20021; G06T 2207/20081; G06T 2207/20084; G06T 2207/20132

(57) ABSTRACT

A computer-implemented method for partially supervised image segmentation having improved strong mask generalization includes obtaining, by a computing system including one or more computing devices, a machine-learned segmentation model, the machine-learned segmentation model including an anchor-free detector model and a deep mask head network, the deep mask head network including an encoder-decoder structure having a plurality of layers. The computer-implemented method includes obtaining, by the computing system, input data including tensor data. The computer-implemented method includes providing, by the computing system, the input data as input to the machine-learned segmentation model. The computer-implemented method includes receiving, by the computing system, output data from the machine-learned segmentation model, the output data including a segmentation of the tensor data, the segmentation including one or more instance masks.

### FIELD

The present disclosure relates generally to segmentation models having improved strong mask generalization. More particularly, the present disclosure relates to segmentation models having an anchor-free detector model and a deep mask head network providing improved strong mask generalization to unseen classes.

### BACKGROUND

Object detection refers to the computer vision task of recognizing and classifying objects in an image, video, or other visual data. Furthermore, segmentation refers to the task of segmenting the visual data into regions depicting the objects and assigning a class to the regions. An object detection model can be trained to detect objects based on training data depicting objects labeled with ground truth data including proper segmentation and/or class assignments. Collecting training data that is properly segmented for all classes can be challenging. Recent work has focused on segmentation using partially supervised training, in which training data for one or more seen classes is labeled with complete segmentation and class assignments, and training data for one or more seen classes is labeled without segmentation, and is instead labeled with cheaper ground truth labels such as bounding boxes. This approach can provide sufficient performance, but may have reduced segmentation performance compared to fully supervised approaches in which all classes are seen classes.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for partially supervised image segmentation having improved strong mask generalization. The computer-implemented method includes obtaining, by a computing system including one or more computing devices, a machine-learned segmentation model, the machine-learned segmentation model including an anchor-free detector model and a deep mask head network, the deep mask head network including an encoder-decoder structure having a plurality of layers. The computer-implemented method includes obtaining, by the computing system, input data including tensor data. The computer-implemented method includes providing, by the computing system, the input data as input to the machine-learned segmentation model. The computer-implemented method includes receiving, by the computing system, output data from the machine-learned segmentation model, the output data including a segmentation of the tensor data, the segmentation including one or more instance masks.

Another example aspect of the present disclosure is directed to one or more non-transitory computer-readable media storing data descriptive of a machine-learned segmentation model. The machine-learned segmentation model includes a feature extractor model configured to receive input tensor data and, in response to receipt of the input tensor data, produce as output a feature map representative of one or more features of the input tensor data. The machine-learned segmentation model includes an anchor-free detector model configured to detect one or more objects of the input data, the anchor-free detector model including one or more tensor heads configured to receive the feature map and, in response to receipt of the feature map, produce as output one or more output object tensors descriptive of objects within the feature map. The machine-learned segmentation model includes an instance segmentation branch configured to provide a segmentation of the input tensor data, the instance segmentation branch including a pixel embedding model configured to receive the feature map and, in response to receipt of the feature map, produce as output an embedding map of the feature map, a per-instance crop model configured to crop a cropped region from the feature map, and a deep mask head network configured to receive at least the cropped region and, in response to receipt of the at least cropped region, produce as output the segmentation of the input tensor data.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs data segmentation according to example embodiments of the present disclosure.

FIG. 1B depicts a block diagram of an example computing device that performs data segmentation according to example embodiments of the present disclosure.

FIG. 1C depicts a block diagram of an example computing device that performs data segmentation according to example embodiments of the present disclosure.

FIG. 2 depicts a block diagram of an example segmentation model according to example embodiments of the present disclosure.

FIG. 3 depicts a block diagram of an example segmentation model according to example embodiments of the present disclosure.

FIG. 4 depicts a block diagram of an example segmentation model according to example embodiments of the present disclosure.

FIG. 5 depicts a flow chart diagram of an example method to perform partially supervised image segmentation having improved strong mask generalization according to example embodiments of the present disclosure.

Reference numerals that are repeated across plural figures are intended to identify the same features in various implementations.

### DETAILED DESCRIPTION

Generally, the present disclosure is directed to systems and methods for partially supervised image segmentation having improved strong mask generalization. Systems and methods according to example aspects of the present disclosure can include a machine-learned segmentation model including an anchor-free detector model and a deep mask head network. The combination of at least some anchor-free and/or keypoint-based detector models, including CenterNet detectors, and a deep mask head network having an encoder-decoder structure and/or greater than a certain number of layers, such as an hourglass network having greater than about 20 layers, can provide improved strong mask generalization. For instance, when the segmentation model is trained using a partially supervised segmentation training dataset including complete ground truth data such as instance masks for some classes, termed seen classes or VOC classes, and less informational ground truth data, such as bounding boxes, for other classes, referred to as unseen classes or non-VOC classes, the segmentation models according to example aspects of the present disclosure can provide improved performance (e.g., as measured by mAP) during inference time in segmentation results for the unseen classes.

Systems and methods according to example aspects of the present disclosure can be especially beneficial in the partially supervised segmentation problem. Conventional segmentation models can be very accurate when trained on large scale datasets including training data annotated with highly informational ground truth data such as instance masks. However, collecting this highly information training data can be expensive, and in some cases can be prohibitively expensive. As one example, collecting segmentation annotations can require on the order of 10 times longer to collect than bounding box annotations.

To remedy this, some systems and methods can employ a partially supervised training regime, in which informationally complete ground truth data, such as, for example, instance masks, is available for some classes, called seen classes or VOC classes, whereas for other classes, called unseen classes or non-VOC classes, this data is not available (e.g., at scale). The segmentation model can learn to generalize to produce complete segmentation outputs (e.g., instance masks) even given the absence of informationally complete training data, albeit with a reduction in performance. In some cases, it is assumed that all classes have at least some informationally minimum level of ground truth data, such as bounding boxes.

Systems and methods according to example aspects of the present disclosure can provide for improved strong mask generalization in the partially supervised segmentation problem. As used herein, strong mask generalization refers to an improved capability of a segmentation model to generalize knowledge learned from training on seen classes in a partially supervised training dataset to unseen classes relative to existing models. For instance, strong mask generalization can refer to a reduced performance differential between segmentation performances on seen classes and unseen classes at inference time. For instance, the present disclosure recognizes that strong mask generalization is a characteristic that is seemingly “unlocked” in some segmentation model architectures, at which point the model can be said to have strong mask generalization. While strong mask generalization does not necessarily imply equal performance on seen and unseen classes, strong mask generalization does provide unexpectedly improved performance on unseen classes for models having this characteristic. For instance, in some implementations, strong mask generalization can double mAP on unseen classes.

Some existing approaches can include anchored detectors, weight transfer, auxiliary losses, offline-trained shape priors, etc. However, these approaches can complicate the models, which can undesirably increase design resources needed to implement the models. In contrast to these approaches, systems and methods according to example aspects of the present disclosure can provide improved performance at partially supervised segmentation without requiring any additional losses or specialized modules, which may otherwise complicate model design. In addition, these approaches may fail to achieve strong mask generalization.

Example aspects of the present disclosure are directed to a machine-learned segmentation model. The segmentation model can be trained to receive a set of input data descriptive of tensor data, such as image data, and, as a result of receipt of the input data, provide output data that includes a segmentation of the input data, such as one or more instance masks. As an example, the segmentation of the input data can include annotations for the input data, such as masks descriptive of a region of the input data and a class associated with the described region. As one visual example, an image depicting a hand holding a cell phone may be segmented using (e.g., at least) two instance masks, including a first mask highlighting the visible portions of the hand and labeled with a “hand” or similar class, and a second mask highlighting the visible portions of the cell phone and labeled with a “cell phone” or similar class. Additionally, bounding boxes defined by one or more corners, a length, a height, or other suitable bounding boxes may be included that contain some or all of the instance masks.

The machine-learned segmentation model can be trained using a partially supervised segmentation training dataset including training data descriptive of one or more seen classes and one or more unseen classes. For instance, a partially supervised segmentation training dataset can include one or more training data entries including ground truth data descriptive of ground truth instance masks for one or more seen classes and ground truth bounding boxes for one or more unseen classes. The partially supervised training dataset can include ground truth data associated with seen classes, which includes a fully informational set of ground truth data, such as an instance mask. Additionally, the partially supervised training dataset can include ground truth data associated with unseen classes, which include a less-than-fully informational set of ground truth data, such as a bounding box. The training data associated with unseen classes may be accurate, but may convey less information than the training data associated with seen classes. A class may be considered a seen class by any suitable criteria, such as if the class includes at least one informationally complete training entry in the partially supervised training set. In some cases, to consider a class a seen class, the class may require a certain amount of informationally complete training entries (e.g., a majority relative to all training entries for that class). At inference time, input data to the segmentation model can include data included in the unseen classes, such as a tensor data item that belongs to an unseen class.

The segmentation model can include an anchor-free detector model configured to detect one or more objects in the input data. The anchor-free detector model can additionally and/or alternatively be a keypoint estimation detector model. The anchor-free detector model can be configured to receive the input data (e.g., tensor data) and, in response to receipt of the input data, produce an object detection output including object detection information such as, for example, object centers (e.g., object center heatmaps), scale tensors, offset tensors, etc. In some implementations, the input data may be used to produce a feature map that is provided to the anchor-free detector model as input in place of the input data.

As referred to herein, an anchor-based detector model can predict classification or box offsets relative to a collection of fixed boxed in a “sliding window” configuration, called anchors. In contrast, an anchor-free detector model may not include anchors, and may instead use alternative forms of detection, such as, for example, keypoint-based estimation. Anchor-based approaches can depend on manually-specified design decisions, e.g. anchor layouts and target assignment heuristics, that present a complex space to navigate for model designers. This complexity can be undesirable as it can contribute to required design resources. In contrast, anchor-free approaches can be simpler, more amenable to extension (e.g. to keypoint prediction), and offer competitive performance.

In some implementations, the segmentation model (e.g., the anchor-free detector model) can include a feature extractor model configured to receive input tensor data and, in response to receipt of the input tensor data, produce as output a feature map representative of one or more features of the input tensor data. The feature extractor model can be a network, such as a fully convolutional neural network. As examples, the feature extractor model can be a ResNet-FPN model, a VoVNet model, an Hourglass network model, or any other suitable feature extractor model.

The anchor-free detector model can include one or more tensor heads configured to receive the feature map and, in response to receipt of the feature map, produce as output one or more output object tensors descriptive of objects within the feature map. The one or more object tensors can include object detection information. As one example, the object tensor(s) can include a center heatmap tensor denoting a heatmap of a plurality of object centers. For each class, the center heatmap can be trained to regress to a target heatmap. The target heatmap can be constructed by splatting a Gaussian bump centered at each bounding box center from ground truth data. The standard deviation of the Gaussian bump can be chosen adaptively based on box size. At test time, the box centers can be selected by finding local maxima in the predicted heatmap. As another example, the object tensor(s) can include a scale tensor trained to regress to the width and height of each object center. As another example, the object tensor(s) can include an offset tensor including a correction term for each of the plurality of object centers to counteract a resolution error. The offset tensors can act as a correction term for each detected object center to correct resolution errors, such as those incurred from using lower-resolution feature maps (e.g., stride-4 or stride-8 on the original input resolution). The object tensors can be lightweight, such as having fewer than about three layers.

As one example, the anchor-free detector model can be a CenterNet detector. CenterNet detectors provide a keypoint-estimation-based and anchor-free detector model that localizes object centers and regresses to other object properties, including, for example, size, 3D location, orientation, pose, etc. In addition, the CenterNet detector can provide for computationally fast performance. The use of CenterNet models according to example aspects of the present disclosure can provide for keypoint-based detection and alleviate design challenges associated with choosing hyperparameters and/or FPN levels, etc. For instance, the use of CenterNet models can provide for strong box detection performance while not requiring complex postprocessing (e.g. NMS) on which many anchor-based architectures rely.

Additionally, according to example aspects of the present disclosure, the segmentation model can include a deep mask head network. The deep mask head network can be configured to receive the input data and produce the segmentation of the input data. Additionally, the deep mask head network may receive at least a portion of the object detection information from the anchor-free detector model, such as, for example, the object centers. According to example aspects of the present disclosure, the deep mask head network can include a plurality of layers, such as ten or more layers. Including a plurality of layers in the deep mask head network could seem counterintuitive due to concerns according to conventional state of the art related to overparameterization of the network. Similar existing systems often include only a small number of layers, such as four or fewer layers. In contrast, the present disclosure recognizes that including a deep backbone network, such as a network having ten or more layers (e.g., twenty layers), can unexpectedly significantly improve strong mask generalization to unseen classes. In some implementations, the deep mask head network can be class-agnostic.

Additionally and/or alternatively, in some implementations, the deep mask head network can have an encoder-decoder structure. For instance, the encoder-decoder structure of the backbone network can include an encoder including one or more encoder layers of the plurality of layers, where the one or more encoder layers are configured to reduce dimensionality. The encoder-decoder structure of the backbone network can additionally include a decoder including one or more decoder layers of the plurality of layers, where the one or more decoder layers are configured to increase dimensionality. For example, the deep mask head network can be an hourglass network. Additionally and/or alternatively, in some implementations, the deep mask head network includes one or more skip connections configured to connect an encoder layer to a decoder layer having a same feature map size as the encoder layer. As one example, the deep mask head network can be an hourglass network including one or more downscaling layers and one or more upscaling layers. For instance, one example implementation includes an hourglass-104 network having 104 layers. Additionally and/or alternatively, the deep mask head network can be a stacked hourglass network that includes a plurality of hourglass networks arranged end to end. Additionally and/or alternatively, in some implementations, the deep mask head network can be a ResNet network. Additionally and/or alternatively, in some implementations, the deep mask head network can include a bottleneck layer. In some implementations, a number of channels can increase throughout the deep mask head network. For instance, in one example implementation, a number of channels in a first layer is set to 64 and gradually increased through successive layers.

The choice of architecture for the deep mask head network can provide strong inductive biases that can greatly affect performance of the models. The present disclosure recognizes that one example implementation including a deep hourglass backbone network and a CenterNet detector provided notable improvements to strong mask generalization. For instance, the hourglass architecture can be also memory efficient due to its successive downsampling layers, which make the feature maps smaller as depth increases. Additionally, the hourglass architecture can encode enough inductive bias by itself that, with no extra losses or additional priors, contemporary state-of-the-art results in data segmentation can be surpassed by a significant margin.

In some implementations, the segmentation model can include an instance segmentation branch configured to provide a segmentation of the input tensor data. The instance segmentation branch can be extended from the anchor-free detector model, such as the CenterNet detector model. As one example, the instance segmentation branch can be extended from a CenterNet detector by the addition of the deep mask head network.

In some implementations, the segmentation model can include a pixel embedding model configured to receive the feature map and, in response to receipt of the feature map, produce as output an embedding map of the feature map. The pixel embedding model can have any suitable number of layers, such as sixteen layers. In some implementations, the segmentation model can include a per-instance crop model configured to crop a cropped region from the feature map. For instance, a cropped region can be cropped from the embedding map of the feature map. As one example, the per-instance crop model can be a ROIAlign model. The instance segmentation branch can additionally include the deep mask head network, which is configured to receive at least the cropped region and, in response to receipt of at least the cropped region, produce as output the segmentation of the input tensor data.

In some implementations, the instance segmentation branch further includes a plurality of coordinate embeddings relative to a plurality of object centers. As one example, in some implementations, the coordinate embeddings can be a fixed embedding of the (e.g., cartesian) coordinates of a bounding box. In some implementations, the instance segmentation branch further includes an instance embedding model configured to extract an embedding vector at each of a plurality of object centers. For instance, the extracted embedding vector can be tiled to a fixed size (e.g., 32×32) and concatenated to the cropped region. Intuitively, this extracted embedding vector conditions the deep mask head network inputs on the instance in addition to the pixels, thus disambiguating pixels that can belong to 2 different instances. For instance, in some implementations, the deep mask head network is configured to receive at least the cropped region and, in response to receipt of the at least cropped region, produce as output the segmentation of the tensor data.

Systems and methods according to example aspects of the present disclosure can provide for a number of technical effects and benefits, including improvements to computing technology. As one example, systems and methods according to example aspects of the present disclosure, such as systems and methods having a segmentation model including an anchor-free detector model and a deep mask head network, can provide for improved strong mask generalization, such as improved accuracy in categorizing objects belonging to classes for which complete ground truth data (e.g., instance masks) is not observed in training. This can provide for improved accuracy in solving classification problems, resulting in improved user experience, improved data collection and/or processing, and/or other improvements to segmentation systems. One example partially-supervised implementation according to example aspects of the present disclosure can even surpass the fully-supervised Oracle Mask-R-CNN in the generalization setting while having comparable mAP.

Additionally and/or alternatively, systems and methods according to example aspects of the present disclosure, such as systems and methods having a segmentation model including an anchor-free detector model and a deep mask head network, can provide for segmentations solutions that are relatively simple, without requiring, for example, additional specialized modules or losses, while still achieving state of the art results on data segmentation. Additionally, systems and methods according to example aspects of the present disclosure can alleviate engineering resources and challenges associated with designing or selecting model hyperparameters and other design decisions. These benefits can be applied to tasks including image processing, such as classification, tasks, which are particularly suited to the described architecture. Other tasks may include the processing of alternative/additional input types, including, but not limited to, audio data, video data and the like.

Example aspects of the present disclosure are discussed with reference to so-called partially supervised training, in which only a subset of training examples are labeled with complete ground truth data (e.g., instance masks) and the remaining training examples are labeled with less complete ground truth data (e.g., bounding boxes). It should be understood that example aspects of the present disclosure may be used in fully supervised training regimes, in some implementations. For instance, example aspects of the present disclosure can provide competitive performance and/or improved generalization even for fully supervised training regimes, although it should be understood that the greatest improvement to generalization is noticed in the partially supervised setting.

With reference now to the Figures, example embodiments of the present disclosure will be discussed in further detail.

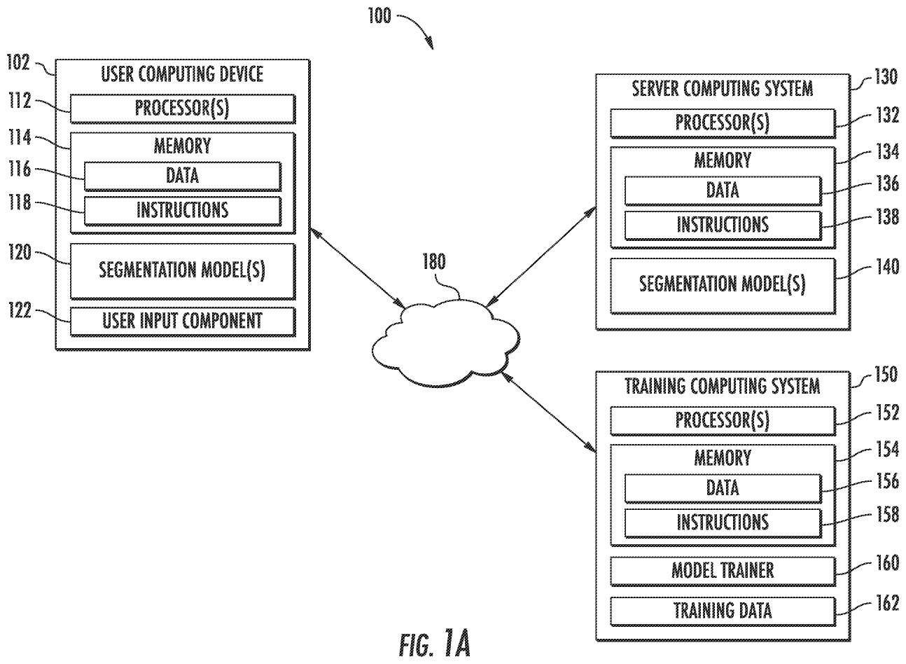

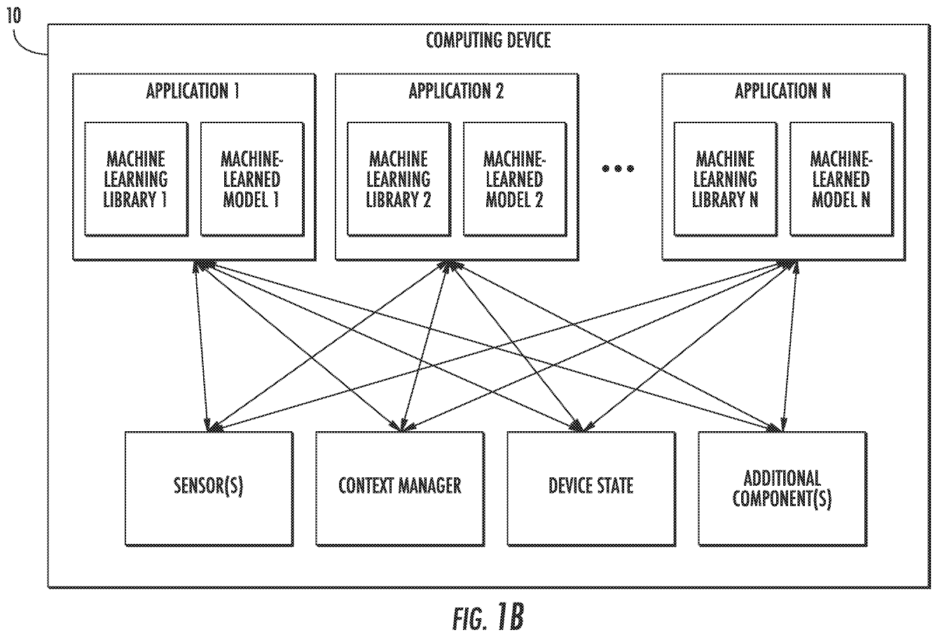

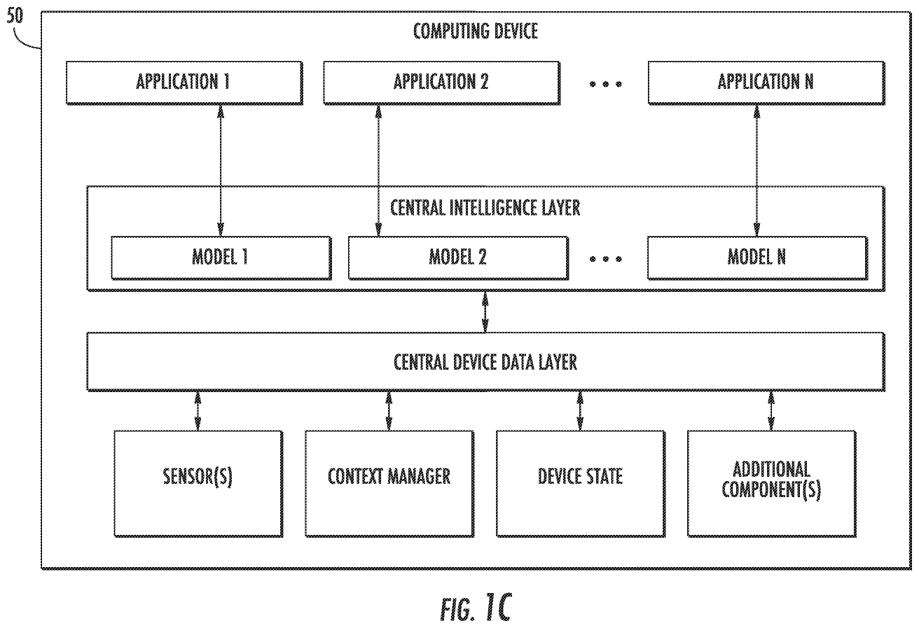

FIG. 1A depicts a block diagram of an example computing system 100 that performs for partially supervised image segmentation having improved strong mask generalization according to example embodiments of the present disclosure. The system 100 includes a user computing device 102, a server computing system 130, and a training computing system 150 that are communicatively coupled over a network 180. The user computing device includes one or more processors 112. The one or more processors 112 can be any suitable processing device (e.g. a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

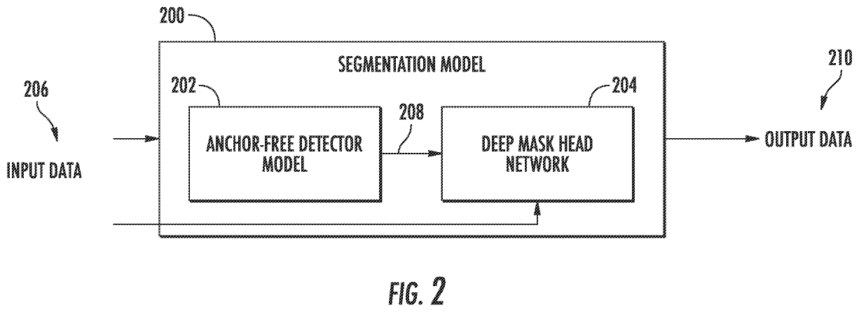

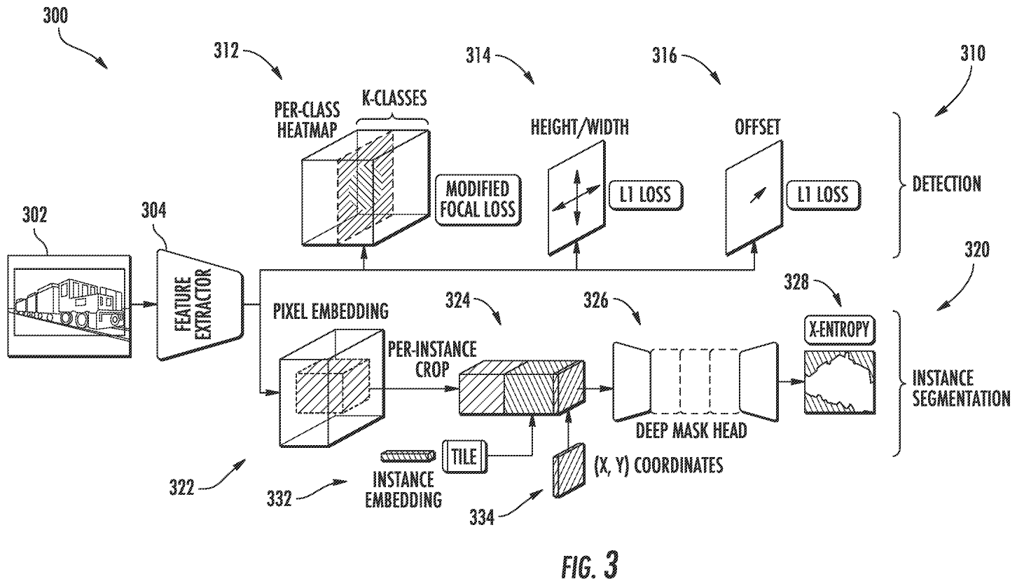

In some implementations, the user computing device 102 can store or include one or more segmentation models 120. For example, the segmentation models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example segmentation models 120 are discussed with reference to FIGS. 2-3.

In some implementations, the one or more segmentation models 120 can be received from the server computing system 130 over network 180, stored in the user computing device memory 114, and then used or otherwise implemented by the one or more processors 112. In some implementations, the user computing device 102 can implement multiple parallel instances of a single segmentation model 120 (e.g., to perform parallel data segmentation across multiple instances of data segmentation applications).

More particularly, in some implementations, the segmentation model(s) 120 are trained to receive a set of input data descriptive of tensor data, such as image data, and, as a result of receipt of the input data, provide output data that includes a segmentation of the input data, such as one or more instance masks. For instance, the segmentation model(s) 120 can include an anchor-free detector model, such as a CenterNet detector. The anchor-free detector model can be configured to receive the input data (e.g., tensor data) and, in response to receipt of the input data, produce an object detection output including object detection information such as, for example, object centers (e.g., object center heatmaps), scale tensors, offset tensors, etc. In some implementations, the input data may be used to produce a feature map that is provided to the anchor-free detector model.

Additionally, the segmentation model(s) 120 can include a deep mask head network. The deep mask head network can receive input data (e.g., a feature map) and/or the object detection output and produce the output data, namely the segmentation of the input data. According to example aspects of the present disclosure, the deep mask head network can include a plurality of layers, such as greater than 4 layers, such as greater than 10 layers, such as 20 or more layers. Additionally and/or alternatively, in some implementations, the deep mask head network can have an encoder-decoder structure. For instance, the encoder-decoder structure of the backbone network can include an encoder including one or more encoder layers of the plurality of layers, where the one or more encoder layers are configured to reduce dimensionality. The encoder-decoder structure of the backbone network can additionally include a decoder including one or more decoder layers of the plurality of layers, where the one or more decoder layers are configured to increase dimensionality. For example, the deep mask head network can be an hourglass network.

Additionally or alternatively, one or more segmentation models 140 can be included in or otherwise stored and implemented by the server computing system 130 that communicates with the user computing device 102 according to a client-server relationship. For example, the segmentation models 140 can be implemented by the server computing system 140 as a portion of a web service (e.g., a data segmentation service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more segmentation models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 2-3.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the segmentation models 120 and/or 140 based on a set of training data 162. The training data 162 can include, for example, partially supervised training data. The partially supervised training data can include tensor data (e.g., image data) labeled with ground truth data descriptive of a segmentation output (e.g., a classification to a plurality of classes and/or a localization) of objects or other features in the tensor data. For instance, the segmentation models 120 and/or 140 can be trained using a partially supervised segmentation training dataset including training data descriptive of one or more seen classes and one or more unseen classes. For instance, a partially supervised segmentation training dataset can include one or more training data entries including ground truth data descriptive of ground truth instance masks for one or more seen classes and ground truth bounding boxes for one or more unseen classes. The partially supervised training dataset can include ground truth data associated with seen classes, which includes a fully informational set of ground truth data, such as an instance mask. Additionally, the partially supervised training dataset can include ground truth data associated with unseen classes, which include a less-than-fully informational set of ground truth data, such as a bounding box. The training data associated with unseen classes may be accurate, but may convey less information than the training data associated with seen classes. A class may be considered a seen class by any suitable criteria, such as if the class includes at least one informationally complete training entry in the partially supervised training set. In some cases, to consider a class a seen class, the class may require a certain amount of informationally complete training entries (e.g., a majority relative to all training entries for that class).

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be sensor data. Sensor data may be image data, video data, audio data or other data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

FIG. 2 depicts a block diagram of an example segmentation model 200 according to example embodiments of the present disclosure. In some implementations, the segmentation model 200 is trained to receive a set of input data 206 descriptive of tensor data, such as image data, and, as a result of receipt of the input data 206, provide output data 210 that includes a segmentation of the input data 206, such as one or more instance masks. For instance, the segmentation model 200 can include an anchor-free detector model 202, such as a CenterNet detector. The anchor-free detector model 202 can be configured to receive the input data 206 (e.g., tensor data) and, in response to receipt of the input data 206, produce an object detection output 208 including object detection information such as, for example, object centers (e.g., object center heatmaps), scale tensors, offset tensors, etc. In some implementations, the input data 206 may be used to produce a feature map that is provided to the anchor-free detector model 202.

Additionally, the example segmentation model 200 can include a deep mask head network 204. The deep mask head network 204 can receive input data 206 (e.g., a feature map) and/or the object detection output 208 and produce the output data 210, namely the segmentation. According to example aspects of the present disclosure, the deep mask head network 204 can include a plurality of layers, such as greater than 4 layers, such as greater than 10 layers, such as 20 or more layers. Additionally and/or alternatively, in some implementations, the deep mask head network 204 can have an encoder-decoder structure. For instance, the encoder-decoder structure of the backbone network can include an encoder including one or more encoder layers of the plurality of layers, where the one or more encoder layers are configured to reduce dimensionality. The encoder-decoder structure of the backbone network can additionally include a decoder including one or more decoder layers of the plurality of layers, where the one or more decoder layers are configured to increase dimensionality. For example, the deep mask head network can be an hourglass network.

FIG. 3 depicts a block diagram of an example segmentation model 300 according to example embodiments of the present disclosure. The segmentation model 300 can be trained to receive a set of input data 302 descriptive of tensor data, such as image data, and, as a result of receipt of the input data 302, provide output data that includes a segmentation 328 of the input data 302, such as one or more instance masks. As an example, the segmentation 328 of the input data 302 can include annotations for the input data 302, such as masks descriptive of a region of the input data 302 and a class associated with the described region. As one visual example, an image depicting a hand holding a cell phone may be segmented using (e.g., at least) two instance masks, including a first mask highlighting the visible portions of the hand and labeled with a “hand” or similar class, and a second mask highlighting the visible portions of the cell phone and labeled with a “cell phone” or similar class. Additionally, bounding boxes defined by one or more corners, a length, a height, or other suitable bounding boxes may be included that contain some or all of the instance masks.

The machine-learned segmentation model 300 can be trained using a partially supervised segmentation training dataset including training data descriptive of one or more seen classes and one or more unseen classes. For instance, a partially supervised segmentation training dataset can include one or more training data entries including ground truth data descriptive of ground truth instance masks for one or more seen classes and ground truth bounding boxes for one or more unseen classes. The partially supervised training dataset can include ground truth data associated with seen classes, which includes a fully informational set of ground truth data, such as an instance mask. Additionally, the partially supervised training dataset can include ground truth data associated with unseen classes, which include a less-than-fully informational set of ground truth data, such as a bounding box. The training data associated with unseen classes may be accurate, but may convey less information than the training data associated with seen classes. A class may be considered a seen class by any suitable criteria, such as if the class includes at least one informationally complete training entry in the partially supervised training set. In some cases, to consider a class a seen class, the class may require a certain amount of informationally complete training entries (e.g., a majority relative to all training entries for that class).

The segmentation model 300 can include an anchor-free detector model 310 configured to detect one or more objects of the input data 302. The anchor-free detector model 310 can additionally and/or alternatively be a keypoint estimation detector model 310. The anchor-free detector model 310 can be configured to receive the input data 302 (e.g., tensor data) and, in response to receipt of the input data 302, produce an object detection output including object detection information such as, for example, object centers (e.g., object center heatmaps), scale tensors, offset tensors, etc. In some implementations, the input data 302 may be used to produce a feature map that is provided to the anchor-free detector model 310 as input in place of the input data 302.

As referred to herein, an anchor-based detector model can predict classification or box offsets relative to a collection of fixed boxed in a “sliding window” configuration, called anchors. In contrast, an anchor-free detector model 310 may not include anchors, and may instead use alternative forms of detection, such as, for example, keypoint-based estimation. Anchor-based approaches can depend on manually-specified design decisions, e.g. anchor layouts and target assignment heuristics, that present a complex space to navigate for model designers. This complexity can be undesirable as it can contribute to required design resources. In contrast, anchor-free approaches can be simpler, more amenable to extension (e.g. to keypoint prediction), and offer competitive performance.

In some implementations, the segmentation model 300 (e.g., the anchor-free detector model 310) can include a feature extractor model 304 configured to receive input tensor data and, in response to receipt of the input tensor data, produce as output a feature map representative of one or more features of the input tensor data. The feature extractor model 304 can be a network, such as a fully convolutional neural network. As examples, the feature extractor model 304 can be a ResNet-FPN model, a VoVNet model, an Hourglass network model, or any other suitable feature extractor model 304.

The anchor-free detector model 310 can include one or more tensor heads configured to receive the feature map and, in response to receipt of the feature map, produce as output one or more output object tensors descriptive of objects within the feature map. The one or more object tensors can include object detection information. As one example, the object tensor(s) can include a center heatmap tensor 312 denoting a heatmap of a plurality of object centers. For each class, the center heatmap can be trained to regress to a target heatmap. The target heatmap can be constructed by splatting a Gaussian bump centered at each bounding box center from ground truth data. The standard deviation of the Gaussian bump can be chosen adaptively based on box size. At test time, the box centers can be selected by finding local maxima in the predicted heatmap. The center heatmap tensor 312 can be trained using a loss including a modified focal loss. As another example, the object tensor(s) can include a scale tensor 314 trained to regress to the width and height of each object center. The scale tensor 314 can be trained using a loss including an L1 loss. As another example, the object tensor(s) can include an offset tensor 316 including a correction term for each of the plurality of object centers to counteract a resolution error. The offset tensor 316 can act as a correction term for each detected object center to correct resolution errors, such as those incurred from using lower-resolution feature maps (e.g., stride-4 or stride-8 on the original input resolution). The offset tensor 316 can be trained using a loss including an L1 loss. The object tensors 312, 314, 316 can be lightweight, such as having fewer than about three layers.

As one example, the anchor-free detector model 310 can be a CenterNet detector. CenterNet detectors provide a keypoint-estimation-based and anchor-free detector model 310 that localizes object centers and regresses to other object properties, including, for example, size, 3D location, orientation, pose, etc. In addition, the CenterNet detector can provide for computationally fast performance. The use of CenterNet models according to example aspects of the present disclosure can provide for keypoint-based detection and alleviate design challenges associated with choosing hyperparameters and/or FPN levels, etc. For instance, the use of CenterNet models can provide for strong box detection performance while not requiring complex postprocessing (e.g. NMS) on which many anchor-based architectures rely.

Additionally, according to example aspects of the present disclosure, the segmentation model 300 can include a deep mask head network 326. The deep mask head network 326 can be configured to receive the input data 302 and produce the segmentation 328 of the input data 302. Additionally, the deep mask head network 326 may receive at least a portion of the object detection information from the anchor-free detector model 310, such as, for example, the object centers. According to example aspects of the present disclosure, the deep mask head network 326 can include a plurality of layers, such as ten or more layers. Including a plurality of layers in the deep mask head network 326 could seem counterintuitive due to concerns according to conventional state of the art related to overparameterization of the network. Similar existing systems often include only a small number of layers, such as four or fewer layers. In contrast, the present disclosure recognizes that including a deep backbone network, such as a network having ten or more layers (e.g., twenty layers), can unexpectedly significantly improve strong mask generalization to unseen classes. In some implementations, the deep mask head network 326 can be class-agnostic.

Additionally and/or alternatively, in some implementations, the deep mask head network 326 can have an encoder-decoder structure. For instance, the encoder-decoder structure of the backbone network can include an encoder including one or more encoder layers of the plurality of layers, where the one or more encoder layers are configured to reduce dimensionality. The encoder-decoder structure of the backbone network can additionally include a decoder including one or more decoder layers of the plurality of layers, where the one or more decoder layers are configured to increase dimensionality. For example, the deep mask head network 326 can be an hourglass network. Additionally and/or alternatively, in some implementations, the deep mask head network 326 includes one or more skip connections configured to connect an encoder layer to a decoder layer having a same feature map size as the encoder layer. As one example, the deep mask head network 326 can be an hourglass network including one or more downscaling layers and one or more upscaling layers. Additionally and/or alternatively, in some implementations, the deep mask head network 326 can be a ResNet network. Additionally and/or alternatively, in some implementations, the deep mask head network 326 can include a bottleneck layer. In some implementations, a number of channels can increase throughout the deep mask head network 326.

In some implementations, the segmentation model 300 can include an instance segmentation branch 320 configured to provide a segmentation of the input tensor data. The instance segmentation branch 320 can be extended from the anchor-free detector model 310, such as the CenterNet detector model 310. As one example, the instance segmentation branch 320 can be extended from a CenterNet detector by the addition of the deep mask head network 326. The instance segmentation branch 320 can be trained by a loss including a cross-entropy loss on the segmentation 328.

In some implementations, the segmentation model 300 can include a pixel embedding model 322 configured to receive the feature map and, in response to receipt of the feature map, produce as output an embedding map of the feature map. The pixel embedding model 322 can have any suitable number of layers, such as sixteen layers. In some implementations, the segmentation model 300 can include a per-instance crop model 324 configured to crop a cropped region from the feature map. For instance, a cropped region can be cropped from the embedding map of the feature map. As one example, the per-instance crop model 324 can be a ROIAlign model. The instance segmentation branch 320 can additionally include the deep mask head network 326, which is configured to receive at least the cropped region and, in response to receipt of at least the cropped region, produce as output the segmentation 328 of the input tensor data.

In some implementations, the instance segmentation branch 320 further includes a plurality of coordinate embeddings 334 relative to a plurality of object centers. As one example, in some implementations, the coordinate embeddings 334 can be a fixed embedding of the (e.g., cartesian) coordinates of a bounding box. In some implementations, the instance segmentation branch 320 further includes an instance embedding model configured to extract an embedding vector 332 at each of a plurality of object centers. For instance, the extracted embedding vector 332 can be tiled to a fixed size (e.g., 32×32) and concatenated to the cropped region. Intuitively, this extracted embedding vector 332 conditions the deep mask head network 326 inputs on the instance in addition to the pixels, thus disambiguating pixels that can belong to 2 different instances. For instance, in some implementations, the deep mask head network 326 is configured to receive at least the cropped region and, in response to receipt of the at least cropped region, produce as output the segmentation 328 of the tensor data.

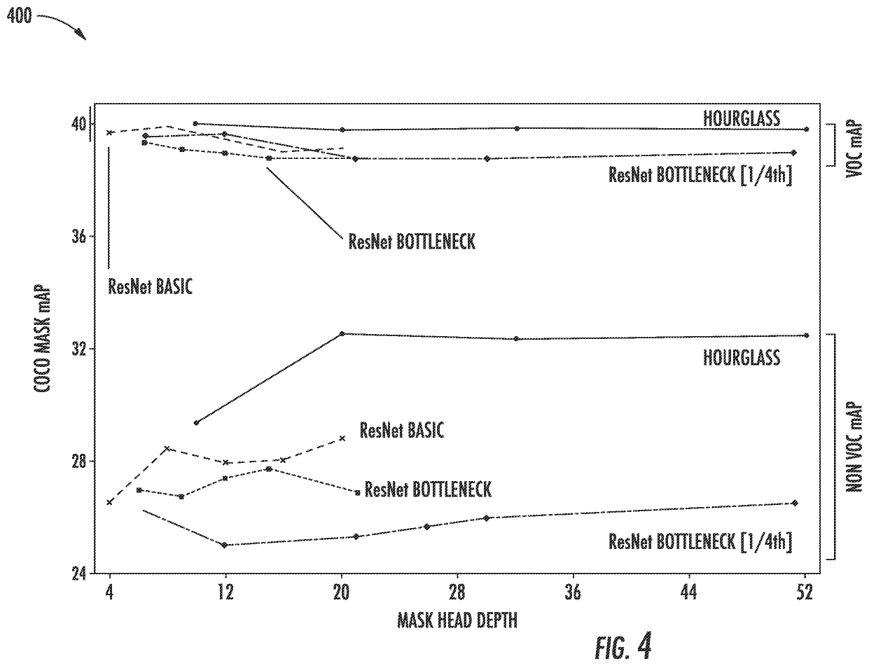

FIG. 4 depicts a plot 400 illustrative of an effect of deep mask head architecture and/or depth on instance segmentation performance over seen classes, or VOC classes, and unseen, or Non-VOC classes. The data in plot 400 is empirically measured from example segmentation models using a CenterNet detector and the given model as a deep mask head network having a number of layers indicated by the X axis. The models are trained using masks only for VOC classes. Performance is evaluated using the “coco-val2017” dataset. As illustrated in FIG. 4, the mAP, a performance metric of the segmentation model, does not vary greatly across different architectures or depths for VOC classes. However, as illustrated in FIG. 4, the mAP for hourglass networks having greater than 20 layers increases compared to mask heads having fewer than 20 layers, and the hourglass network itself provides improved performance across all classes and especially on VOC classes. It should be understood that these results are not necessarily generalizable to all example implementations of the present disclosure, but rather serve to illustrate the improved strong mask generalization achievable by the combination of an anchor-free detector network (in this example, a CenterNet detector) and an hourglass deep mask head network (in this example, a bottleneck network having greater than 20 layers).

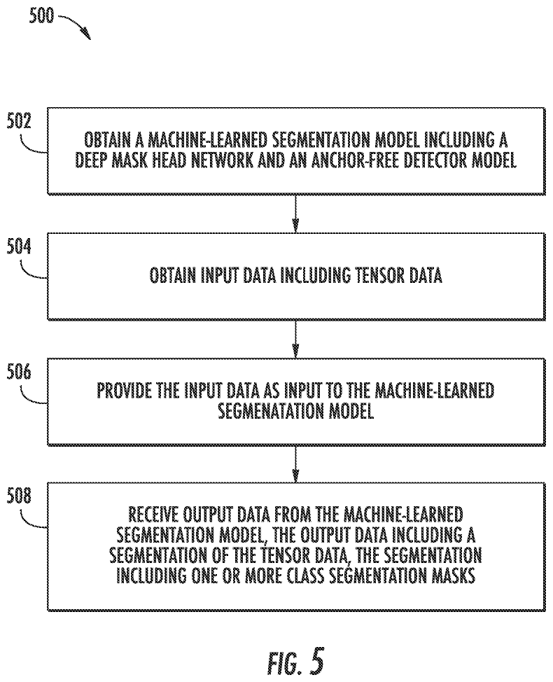

FIG. 5 depicts a flow chart diagram of an example method to perform partially supervised image segmentation having improved strong mask generalization according to example embodiments of the present disclosure. Although FIG. 5 depicts steps performed in a particular order for purposes of illustration and discussion, the methods of the present disclosure are not limited to the particularly illustrated order or arrangement. The various steps of the method 500 can be omitted, rearranged, combined, and/or adapted in various ways without deviating from the scope of the present disclosure.

The method 500 can include, at 502, obtaining (e.g., by a computing system including one or more computing devices) a machine-learned segmentation model including a deep mask head network and an anchor-free detector model. In some implementations, the anchor-free detector model can be a CenterNet detector model. In some implementations, the deep mask head network can be an hourglass network. Additionally and/or alternatively, in some implementations, the deep mask head network can be a ResNet network. In some implementations, a number of channels increases gradually throughout the deep mask head network.

The deep mask head network can include an encoder-decoder structure having a plurality of layers. For instance, the encoder-decoder structure of the backbone network can include an encoder including one or more encoder layers of the plurality of layers, the one or more encoder layers configured to reduce dimensionality. The structure can additionally include a decoder including one or more decoder layers of the plurality of layers, the one or more decoder layers configured to increase dimensionality. In some implementations, the plurality of layers can include greater than 10 layers. In some implementations, the deep mask head network can include one or more skip connections configured to connect an encoder layer to a decoder layer having a same feature map size as the encoder layer. In some implementations, the deep mask head network can include a bottleneck layer.

The method 500 can include, at 504, obtaining (e.g., by the computing system) input data including tensor data. The tensor data can be any suitable tensor data, such as, for example, image or other visual data depicting one or more objects. The tensor data can be obtained from any suitable source, such as, for example, computer-readable media (e.g., removable media), one or more cameras, one or more external sources (e.g., a website), and/or any other suitable sources.

The method 500 can include, at 506, providing (e.g., by the computing system) the input data as input to the machine-learned segmentation model. For instance, the input data can be provided as input to the machine-learned segmentation model as part of a segmentation service or other object detection service.

In some implementations, the machine-learned segmentation model can include a feature extractor model configured to receive input tensor data and, in response to receipt of the input tensor data, produce as output a feature map representative of one or more features of the input tensor data. Providing (e.g., by the computing system) the input data as input to the machine-learned segmentation model can thus include providing (e.g., by the computing system) the input data as input to the feature extractor model and receiving (e.g., by the computing system) a feature map representative of one or more features of the input data.

In some implementations, the anchor-free detector model can include one or more tensor heads configured to receive an input feature map and, in response to receipt of the input feature map, produce as output one or more output object tensors descriptive of objects within the input feature map. Providing (e.g., by the computing system) the input data as input to the machine-learned segmentation model can thus include providing (e.g., by the computing system) the feature map representative of one or more features of the input data to the one or more tensor heads and receiving (e.g., by the computing system) one or more object tensors descriptive of objects within the feature map. In some implementations, the one or more object tensors can include a center heatmap tensor denoting a heatmap of a plurality of object centers, a scale tensor trained to regress to the width and height of each object center, and an offset tensor including a correction term for each of the plurality of object centers to counteract a resolution error.

In some implementations, the machine-learned segmentation model can include an instance segmentation branch. For instance, the instance segmentation branch can include a pixel embedding model configured to receive an input feature map and, in response to receipt of the input feature map, produce as output an output embedding map of the input feature map. Providing (e.g., by the computing system) the input data as input to the machine-learned segmentation model can thus include providing (e.g., by the computing system) the feature map representative of one or more features of the input data to the one or more tensor heads and receiving (e.g., by the computing system) an embedding map of the feature map.

In some implementations, the instance segmentation branch further includes a per-instance crop model configured to crop a cropped region from the feature map. For example, the per-instance crop model can be or can include a ROIAlign model. In some implementations, the instance segmentation branch further includes a plurality of coordinate embeddings relative to a plurality of object centers. In some implementations, the instance segmentation branch further includes an instance embedding model configured to extract an embedding vector at each of a plurality of object centers. For instance, the deep mask head network can be configured to receive at least the cropped region and, in response to receipt of the at least cropped region, produce as output the segmentation of the tensor data.

The method 500 can include, at 508, receiving (e.g., by the computing system) output data from the machine-learned segmentation model. The output data can include a segmentation of the tensor data. For instance, the segmentation can include one or more instance masks. It should be readily apparent to one of ordinary skill in the art that the segmentation output from the machine-learned segmentation model can have a variety of useful applications related to data segmentation. As one example, the segmented data can be provided to a user by unique visual indicia (e.g., distinct shading), such as via an overlay on the input data. As another example, the segmented data can be used to target or otherwise guide data processing.

In some implementations, the machine-learned segmentation model can be trained using a partially supervised segmentation training dataset including training data descriptive of one or more seen classes and one or more unseen classes. For instance, a partially supervised segmentation training dataset can include one or more training data entries including ground truth data descriptive of ground truth instance masks for one or more seen classes and ground truth bounding boxes for one or more unseen classes. Systems and methods according to example aspects of the present disclosure (e.g., the method 500) can provide for improved strong mask generalization to the one or more unseen classes. For instance, at inference time, input data to the segmentation model (e.g., tensor data) can include data belonging to at least one of the one or more unseen classes, which may be properly segmented by the segmentation model based at least in part on the improved strong mask generalization.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method for partially supervised image segmentation having improved strong mask generalization, the method comprising:
obtaining, by a computing system comprising one or more computing devices, a machine-learned segmentation model, the machine-learned segmentation model comprising an anchor-free detector model and a deep mask head network, the deep mask head network comprising an encoder-decoder structure having a plurality of layers;
obtaining, by the computing system, input data comprising tensor data;
providing, by the computing system, the input data as input to the machine-learned segmentation model; and
receiving, by the computing system, output data from the machine-learned segmentation model, the output data comprising a segmentation of the tensor data, the segmentation comprising one or more instance masks.

2. The computer-implemented method of claim 1, wherein the machine-learned segmentation model is trained using a partially supervised segmentation training dataset comprising one or more training data entries comprising ground truth data descriptive of ground truth instance masks for one or more seen classes and ground truth bounding boxes for one or more unseen classes, and wherein the input data comprises data included in one of the unseen classes.

3. The computer-implemented method of claim 1, wherein the anchor-free detector model comprises a CenterNet detector model.

4. The computer-implemented method of claim 1, wherein the encoder-decoder structure of the backbone network comprises an encoder comprising one or more encoder layers of the plurality of layers, the one or more encoder layers configured to reduce dimensionality, and a decoder comprising one or more decoder layers of the plurality of layers, the one or more decoder layers configured to increase dimensionality.

5. The computer-implemented method of claim 4, wherein the deep mask head network comprises one or more skip connections configured to connect an encoder layer to a decoder layer having a same feature map size as the encoder layer.

6. The computer-implemented method of claim 1, wherein the plurality of layers comprises greater than 10 layers.

7. The computer-implemented method of claim 1, wherein the machine-learned segmentation model comprises a feature extractor model configured to receive input tensor data and, in response to receipt of the input tensor data, produce as output a feature map representative of one or more features of the input tensor data; and
wherein providing, by the computing system, the input data as input to the machine-learned segmentation model comprises:
providing, by the computing system, the input data as input to the feature extractor model; and
receiving, by the computing system, a feature map representative of one or more features of the input data.

8. The computer-implemented model of claim 7, wherein the anchor-free detector model comprises one or more tensor heads configured to receive an input feature map and, in response to receipt of the input feature map, produce as output one or more output object tensors descriptive of objects within the input feature map; and
wherein providing, by the computing system, the input data as input to the machine-learned segmentation model comprises:
providing, by the computing system, the feature map representative of one or more features of the input data to the one or more tensor heads; and
receiving, by the computing system, one or more object tensors descriptive of objects within the feature map.

9. The computer-implemented method of claim 8, wherein the one or more object tensors comprise a center heatmap tensor denoting a heatmap of a plurality of object centers, a scale tensor trained to regress to the width and height of each object center, and an offset tensor comprising a correction term for each of the plurality of object centers to counteract a resolution error.

10. The computer-implemented method of claim 7, wherein the machine-learned segmentation model comprises an instance segmentation branch, the instance segmentation branch comprising a pixel embedding model configured to receive an input feature map and, in response to receipt of the input feature map, produce as output an output embedding map of the input feature map; and
wherein providing, by the computing system, the input data as input to the machine-learned segmentation model comprises:
providing, by the computing system, the feature map representative of one or more features of the input data to the one or more tensor heads; and
receiving, by the computing system, an embedding map of the feature map.

11. The computer-implemented method of claim 10, wherein the instance segmentation branch further comprises a per-instance crop model configured to crop a cropped region from the feature map.

12. The computer-implemented method of claim 11, wherein the per-instance crop model comprises a ROIAlign model.

13. The computer-implemented method of claim 10, wherein the instance segmentation branch further comprises a plurality of coordinate embeddings relative to a plurality of object centers.

14. The computer-implemented method of claim 10, wherein the instance segmentation branch further comprises an instance embedding model configured to extract an embedding vector at each of a plurality of object centers.

15. The computer-implemented method of claim 11, wherein the deep mask head network is configured to receive at least the cropped region and, in response to receipt of the at least cropped region, produce as output the segmentation of the tensor data.

16. The computer-implemented method of claim 1, wherein the deep mask head network comprises an hourglass network.

17. The computer-implemented method of claim 1, wherein the deep mask head network comprises a ResNet network.

18. The computer-implemented method of claim 1, wherein a number of channels increases gradually throughout the deep mask head network.

19. The computer-implemented method of claim 1, wherein the deep mask head network comprises a bottleneck layer.

20. One or more non-transitory computer-readable media storing data descriptive of a machine-learned segmentation model, the machine-learned segmentation model comprising:
a feature extractor model configured to receive input tensor data and, in response to receipt of the input tensor data, produce as output a feature map representative of one or more features of the input tensor data;
an anchor-free detector model configured to detect one or more objects of the input data, the anchor-free detector model comprising one or more tensor heads configured to receive the feature map and, in response to receipt of the feature map, produce as output one or more output object tensors descriptive of objects within the feature map; and
an instance segmentation branch configured to provide a segmentation of the input tensor data, the instance segmentation branch comprising:
a pixel embedding model configured to receive the feature map and, in response to receipt of the feature map, produce as output an embedding map of the feature map;
a per-instance crop model configured to crop a cropped region from the feature map; and
a deep mask head network configured to receive at least the cropped region and, in response to receipt of the at least cropped region, produce as output the segmentation of the input tensor data.
